(19) United States
(12) Patent Application Publication
(10) Pub. No.: US 2010/0226671 A1
(43) Pub. Date: Sep. 9, 2010

(54) IMAGE FORMING APPARATUS AND IMAGE FORMING METHOD

(75) Inventors: Nobuyuki MIZUSHIMA, Shiojiri-shi (JP); Yujiro NOMURA, Shiojiri-shi (JP); Ken IKUMA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/710,799

(22) Filed: Feb. 23, 2010

(30) Foreign Application Priority Data
Mar. 9, 2009 (JP) 2009-054671

(51) Int. Cl. G03G 15/043; G03G 15/10

(52) U.S. Cl. 399/51; 399/249; 399/239

(57) ABSTRACT

An image forming apparatus includes: a latent image bearing drum that rotates and on which a latent image is formed; an exposure head having a first light-emitting element that exposes a first region of the latent image bearing drum and a second light-emitting element that exposes a second region of the latent image bearing drum; a storage unit that stores first speed-related information relating to the rotational speed of the first region of the latent image bearing drum and second speed-related information relating to the rotational speed of the second region of the latent image bearing drum; and a light-emission timing adjustment unit that adjusts the timing of the light emission of the first light-emitting element based on the first speed-related information and adjusts the timing of the light emission of the second light-emitting element based on the second speed-related information.

### BACKGROUND

1. Technical Field

The present invention relates to an image forming apparatus and image forming method that use an exposure head to form a latent image upon a latent image bearing drum.

2. Related Art

An image forming apparatus that uses an exposure head to expose a latent image bearing drum such as a photosensitive drum, thus forming a latent image upon the latent image bearing drum, has been known for some time. Such an image forming apparatus is disclosed in, for example, JP-A-2008-170602. To be more specific, with this image forming apparatus, the latent image bearing drum is rotationally driven central to a rotation shaft, and the circumferential surface of the latent image bearing drum rotates in a direction that is orthogonal or approximately orthogonal to the direction of the rotation shaft. Furthermore, the exposure head is provided with multiple light-emitting elements arranged in the direction of the rotation shaft of the latent image bearing drum, and causing these multiple light-emitting elements to emit light makes it possible to form, upon the circumferential surface of the latent image bearing drum, one line's worth of a latent image extending in the direction of the rotation shaft. Repeatedly causing the light-emitting elements of the exposure head to emit light at an emission timing based on the movement of the latent image bearing drum makes it possible to obtain a two-dimensional latent image on the circumferential surface of the latent image bearing drum.

In addition, a developer is provided downstream from the exposure head in the movement direction of the circumferential surface of the latent image bearing drum, and latent images formed upon the circumferential surface of the latent image bearing drum are developed into toner images by the developer. Furthermore, on the downstream side of the developer in the movement direction of the circumferential surface of the latent image bearing drum, the surface of a transfer medium such as a transfer belt makes contact with the circumferential surface of the latent image bearing drum while moving in the movement direction of the circumferential surface of the latent image bearing drum, thereby forming a transfer region. Accordingly, the toner image is transferred from the circumferential surface of the latent image bearing drum to the surface of the transfer medium at the transfer region. In this manner, a two-dimensional image can be obtained on the surface of the transfer medium.

Incidentally, in order to perform such image formation in a favorable manner, it is desirable for the movement speed of the circumferential surface of the latent image bearing drum (the rotational speed) to be the same in all regions in the direction of the rotation shaft. The reason for this is that if, for example, the rotational speed of the region at one end in the direction of the rotation shaft is different from the rotational speed of the region at the other end in the direction of the rotation shaft, the portion of the image transferred onto the transfer medium corresponding to the region at the one end will be expanded or compressed compared to the portion corresponding to the region at the other end, and there is thus a risk that image formation defects, such as distortion in the image, will occur. However, in reality, it is difficult to configure an image forming apparatus so that the movement speed of the circumferential direction of the latent image bearing drum (the rotational speed) is the same in all regions in the direction of the rotation shaft. Accordingly, when attempting, for example, to realize high-resolution images, there have been cases where the aforementioned image formation defects have occurred to a degree that is not permissible.

### SUMMARY

An advantage of some aspects of the invention is to provide a technique that enables a favorable image to be formed even in the case where the rotational speed of a latent image bearing drum differs depending on the region.

An image forming apparatus according to an aspect of the invention includes: a latent image bearing drum that rotates and on which a latent image is formed; an exposure head having a first light-emitting element that exposes a first region of the latent image bearing drum and a second light-emitting element that exposes a second region of the latent image bearing drum; a storage unit that stores first speed-related information relating to the rotational speed of the first region of the latent image bearing drum and second speed-related information relating to the rotational speed of the second region of the latent image bearing drum; and a light-emission timing adjustment unit that adjusts the timing of the light emission of the first light-emitting element based on the first speed-related information and adjusts the timing of the light emission of the second light-emitting element based on the second speed-related information.

Meanwhile, an image forming method according to an aspect of the invention includes: adjusting the timing of the light emission of a first light-emitting element that exposes a first region of a latent image bearing drum that rotates and which is exposed to form a latent image, based on first speed-related information relating to the rotational speed of the first region of the latent image bearing drum; and adjusting the timing of the light emission of a second light-emitting element that exposes a second region of a latent image bearing drum that rotates and which is exposed to form a latent image, based on second speed-related information relating to the rotational speed of the second region of the latent image bearing drum.

With the aspects (the image forming apparatus and image forming method) configured in this manner in the past, the first light-emitting element and the second light-emitting element expose the latent image bearing drum in different regions (the first region and the second region). Accordingly, there has been the risk of the occurrence of image formation defects such as those described above when the rotational speed of the first region and the rotational speed of the second region differ from each other. As opposed to this, with this invention, the light-emission timing of the first light-emitting element is adjusted based on the first speed-related information relating to the rotational speed of the first region, and the light-emission timing of the second light-emitting element is adjusted based on the second speed-related information relating to the rotational speed of the second region. Accordingly, it is possible to suppress image formation defects such as those described above and favorably form images even in the case where the rotational speed of the first region and the rotational speed of the second region differ from each other.

Incidentally, there are situations where the latent image bearing drum slants relative to its rotation shaft, as will be described later. In such a situation, a complicated state arises in which the rotational speed of the first region and the rotational speed of the second region not only differ from each other, but also experience various degrees of fluctuation over time. However, this fluctuation in rotational speed is cyclic, and the cycle thereof corresponds to the period in which the latent image bearing drum makes one rotation. Accordingly, it is preferable that the first speed-related information relate to the rotational speed of the first region during the period in which the latent image bearing drum makes one rotation, and the second speed-related information relate to the rotational speed of the second region during the period in which the latent image bearing drum makes one rotation. The reason for this is that with such a configuration, even in the case where such a complicated rotational speed fluctuation occurs, it is possible to favorably form an image regardless of that rotational speed fluctuation.

In addition, the invention can be applied to an image forming apparatus that includes a developing unit that develops the latent image formed on the latent image bearing drum using a liquid developer that contains a liquid carrier and toner and a first squeeze roller that makes contact with the latent image bearing drum and removes the liquid carrier from an image developed by the developing unit. However, with such an image forming apparatus, the amount of the liquid carrier tends to decrease in the vicinity of the first squeeze roller (more than, for example, in the vicinity of the developing unit), and when the amount of the liquid carrier decreases in this manner, there are situations where the operation of the squeeze roller affects the rotational speed of the latent image bearing drum, causing a breakdown in the cyclicity of the rotational speed fluctuation of the first region or second region in the rotational cycle of the latent image bearing drum. Accordingly, it is preferable that the configuration be such that the rotational cycle of the latent image bearing drum is an integral multiple of the rotational cycle of the first squeeze roller. By employing such a configuration, even if the first squeeze roller affects the rotational speed of the first region or second region of the latent image bearing drum, the cyclicity of the rotational speed fluctuation of the first region or second region can be maintained in the rotational cycle of the latent image bearing drum. Accordingly, this configuration is advantageous with respect to favorable image formation.

In addition, the invention can be applied in an image forming apparatus that includes a second squeeze roller that makes contact with the latent image bearing drum and removes the liquid carrier from the image from which the liquid carrier has been removed by the first squeeze roller. However, because there is even less liquid carrier in the vicinity of the second squeeze roller than liquid carrier in the vicinity of the first squeeze roller, the second squeeze roller tends to affect the rotational speed of the first region or second region of the latent image bearing drum. There is thus a risk that the cyclicity of the rotational speed fluctuation of the first region or second region will break down in the rotational cycle of the latent image bearing drum due to the second squeeze roller. Accordingly, it is preferable that the configuration be such that the rotational cycle of the latent image bearing drum is an integral multiple of the rotational cycle of the second squeeze roller. The reason for this is that with such a configuration, the cyclicity of the rotational speed fluctuation of the first region or second region in the rotational cycle of the latent image bearing drum can be maintained, which is advantageous in terms of favorable image formation.

In addition, the invention can be applied in an image forming apparatus in which the developing unit includes a developing roller that makes contact with the latent image bearing drum and supplies the liquid developer to the latent image bearing drum. However, with such an image forming apparatus, the developing roller makes contact with the latent image bearing drum, and thus there are situations where the developing roller affects the rotational speed of the first region or second region of the latent image bearing drum; as a result, there is a risk that the cyclicity of the rotational speed fluctuation of the first region or second region will break down in the rotational cycle of the latent image bearing drum due to the developing roller. Accordingly, it is preferable that the configuration be such that the rotational cycle of the latent image bearing drum is an integral multiple of the rotational cycle of the developing roller. The reason for this is that with such a configuration, the cyclicity of the rotational speed fluctuation of the first region or second region in the rotational cycle of the latent image bearing drum can be maintained, which is advantageous in terms of favorable image formation.

In addition, the invention can be applied to an image forming apparatus that includes a charge roller that makes contact with the latent image bearing drum and charges the latent image bearing drum. However, with such an image forming apparatus, the charge roller makes contact with the latent image bearing drum, and thus there are situations where the charge roller affects the rotational speed of the first region or second region of the latent image bearing drum; as a result, there is a risk that the cyclicity of the rotational speed fluctuation of the first region or second region will break down in the rotational cycle of the latent image bearing drum due to the charge roller. Accordingly, it is preferable that the configuration be such that the rotational cycle of the latent image bearing drum is an integral multiple of the rotational cycle of the charge roller. The reason for this is that with such a configuration, the cyclicity of the rotational speed fluctuation of the first region or second region in the rotational cycle of the latent image bearing drum can be maintained, which is advantageous in terms of favorable image formation.

### BRIEF DESCRIPTION OF THE DRAWINGS

The invention will be described with reference to the accompanying drawings, wherein like numbers reference like elements.

FIG. 1 is a diagram illustrating an image forming apparatus according to an embodiment of the invention.

FIG. 2 is a diagram illustrating the electrical configuration of the image forming apparatus illustrated in FIG. 1.

FIG. 3 is a partial perspective view illustrating the structure of a line head.

FIG. 4 is a partial cross-section illustrating a widthwise cross-section of a line head.

FIG. 5 is a partial diagram illustrating the configuration of a developing unit.

FIG. 6 is a partial side view illustrating a rotation mechanism for squeeze rollers.

FIG. 7 is a diagram illustrating the surface speed of a photosensitive drum in the case where the photosensitive drum is slanted relative to a rotation shaft.

FIG. 8 is a plan view illustrating the grouping of light-emitting elements.

FIG. 9 is a block diagram illustrating an electrical configuration for adjusting the timing of light emission.

FIG. 10 is a diagram illustrating compensation operations for a horizontal request signal based on a profile.

FIG. 11 is a diagram illustrating compensation operations for a horizontal request signal based on a profile.

FIG. 12 is a graph illustrating frictional force that acts in a primary transfer region.

FIG. 13 is a partial perspective view illustrating another method for finding a profile.

### DESCRIPTION OF EXEMPLARY EMBODIMENTS

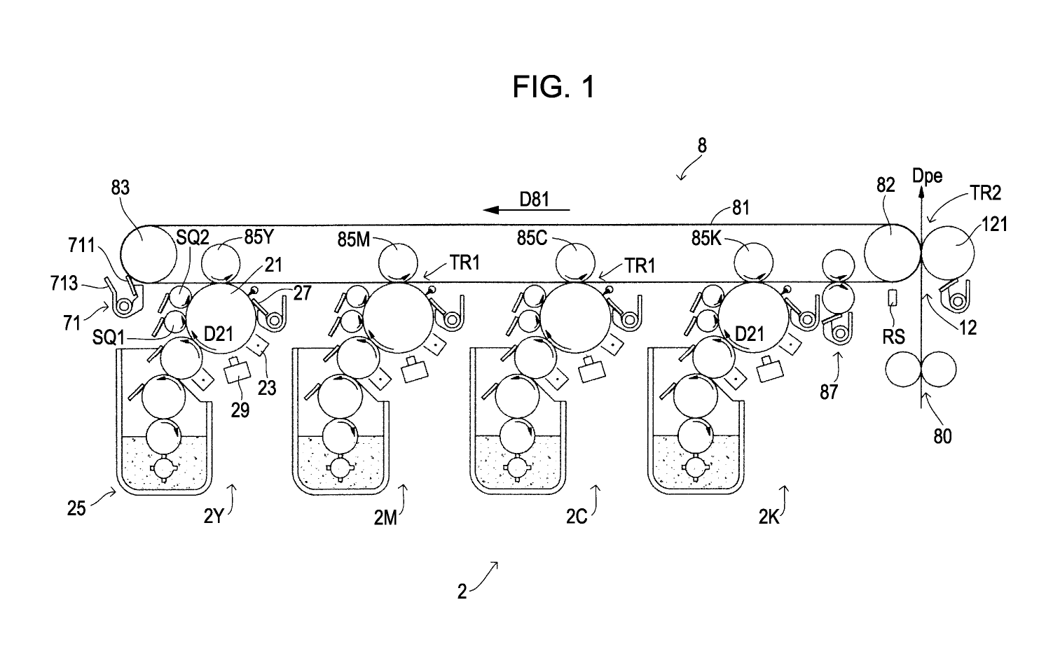

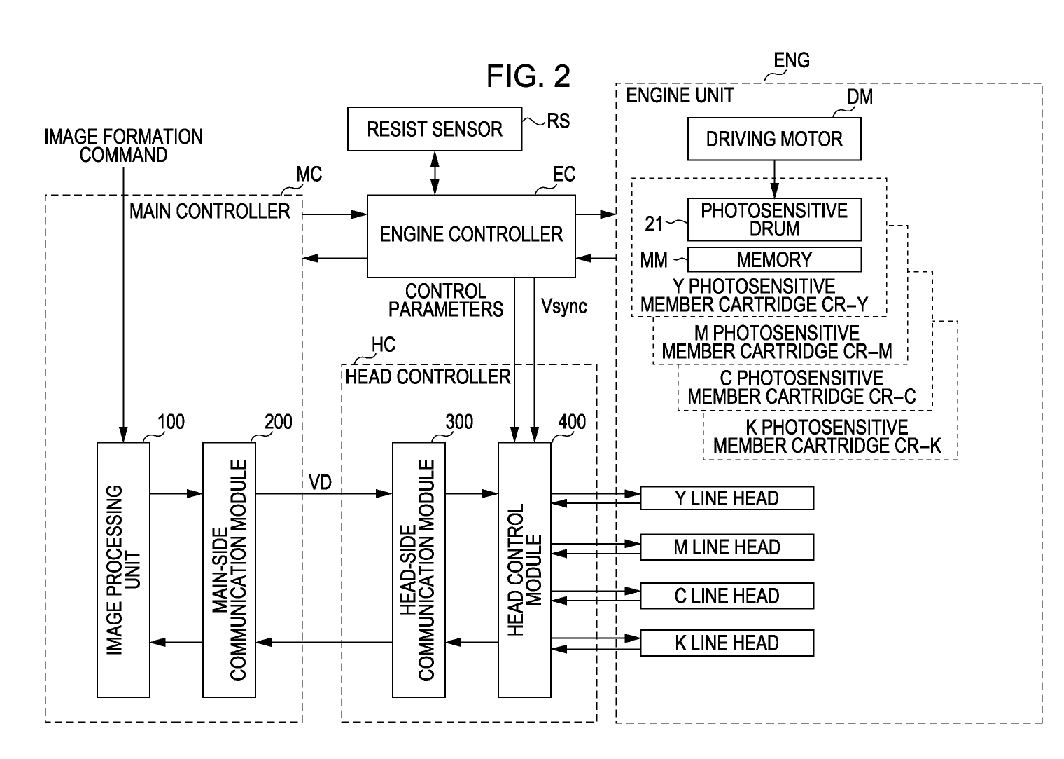

FIG. 1 is a diagram illustrating an image forming apparatus according to an embodiment of the invention. FIG. 2 is a diagram illustrating the electrical configuration of the image forming apparatus illustrated in FIG. 1. This apparatus is an image forming apparatus capable of selectively executing a color mode, in which a color image is formed by superimposing toners of four colors, or yellow (Y), magenta (M), cyan (C), and black (K), and a monochromatic mode, in which a monochromatic image is formed using only black (K) toner. With this image forming apparatus, when an image formation command is supplied from an external device such as a host computer to a main controller MC that includes a CPU, a memory, and the like, the main controller MC supplies a control signal to an engine controller EC, and based on that signal, the engine controller EC controls various units in the apparatus, such as an engine portion ENG and a head controller HC, so as to execute predetermined image formation operations. An image corresponding to the image formation command is formed upon a recording material/sheet such as copy paper, transfer paper, form paper, clear sheets used in OHPs, and so on.

An electrical equipment box (not shown) including a power source circuit board, the main controller MC, the engine controller EC, and the head controller HC is provided within a housing body (not shown) with which the image forming apparatus according to this embodiment is provided. Furthermore, an image forming unit 2, a transfer belt unit 8, and a secondary transfer unit 12 are also disposed within the housing body.

The image forming unit 2 includes four image forming stations, or 2Y (for yellow), 2M (for magenta), 2C (for cyan), and 2K (for black), that form images of their respective colors. Note that in FIG. 1, the configurations of the image forming stations in the image forming unit 2 are identical, and thus for the sake of simplicity, reference numerals have been given only to some of the image forming stations and have been omitted with respect to the other image forming stations.

Each of the image forming stations 2Y, 2M, 2C, and 2K are provided with a photosensitive drum 21, on the surface of which a color image of the corresponding color is formed. The photosensitive drums 21 hold dedicated photosensitive member cartridges CR-Y, CR-M, CR-C, and CR-K, respectively, and the photosensitive member cartridges CR-Y to CR-K are configured so as to be attachable integrally with the apparatus itself and removable from the apparatus. Furthermore, each of the photosensitive member cartridges CR-Y to CR-K is provided with a non-volatile memory MM for storing information related to that photosensitive member cartridge. Wireless communication is carried out between the engine controller EC and the photosensitive member cartridges CR-Y to CR-K. With such a configuration, the information related to the photosensitive member cartridges CR-Y to CR-K can be transmitted to the engine controller EC, and the information in the memories MM can be updated and stored as necessary. Based on this information, the usage history, lifespan of consumable articles, and so on in the photosensitive member cartridges CR-Y to CR-K can be managed.

Meanwhile, in a state where the photosensitive member cartridges are installed, each photosensitive drum 21 is disposed so that its rotation shaft is parallel or approximately parallel to the main scanning direction MD (in FIG. 1, the direction vertical relative to the paper surface). Furthermore, the rotation shafts of the photosensitive drums 21 are respectively connected to dedicated driving motors DM, and are rotationally driven at a predetermined speed in the direction of an arrow D21 shown in FIG. 1. Through this, the surface of each photosensitive drum 21 is transported in the sub scanning direction SD, which is orthogonal or approximately orthogonal relative to the main scanning direction MD. In this manner, rather than providing a driving transmission mechanism such as gears or the like between the rotation shafts of the photosensitive drums 21 and the driving motors DM, this embodiment employs a direct-drive system in which the rotation shafts of the photosensitive drums 21 are driven directly by the driving motors DM. Note that while only the driving motor DM that drives the yellow (Y) photosensitive drum 21 is shown in FIG. 2, driving motors DM are also provided for the other colors (M), (C), and (K).

Meanwhile, a charging unit 23, a line head 29, a developing unit 25, squeeze rollers SQ1 and SQ2, and a photosensitive member cleaner 27 are disposed in the periphery of each photosensitive drum 21, along the rotational direction thereof. Discharge operations, latent image forming operations, toner developing operations, and so on are executed by these functional units. When executing the color mode, toner images formed at all of the image forming stations 2Y, 2M, 2C, and 2K are superimposed on a transfer belt 81 that is provided in the transfer belt unit 8, thereby forming a color image. On the other hand, when executing the monochromatic mode, only the image forming station 2K is operated, thereby forming a monochromatic black image.

The charging unit 23 is configured of a so-called corona charging unit, and is a non-contact charging unit that does not make contact with the surface of the photosensitive drum 21. The charging unit 23 is connected to a discharge voltage generation unit (not shown), and upon receiving a supply of electricity from the discharge voltage generation unit, the charging unit 23 charges the surface of the photosensitive drum 21 to a predetermined surface potential at a charge position that is opposite to the photosensitive drum 21.

The line head 29 is disposed so that its lengthwise direction LGD is parallel or approximately parallel to the main scanning direction MD, and so that its widthwise direction LTD is parallel or approximately parallel to the sub scanning direction SD. The line head 29 includes multiple light-emitting elements arranged in the lengthwise direction LGD, and is disposed opposite to the photosensitive drum 21. The light emitted from the light-emitting elements is projected onto the surface of the photosensitive drum 21 that has been charged by the charging unit 23, thereby forming an electrostatic latent image.

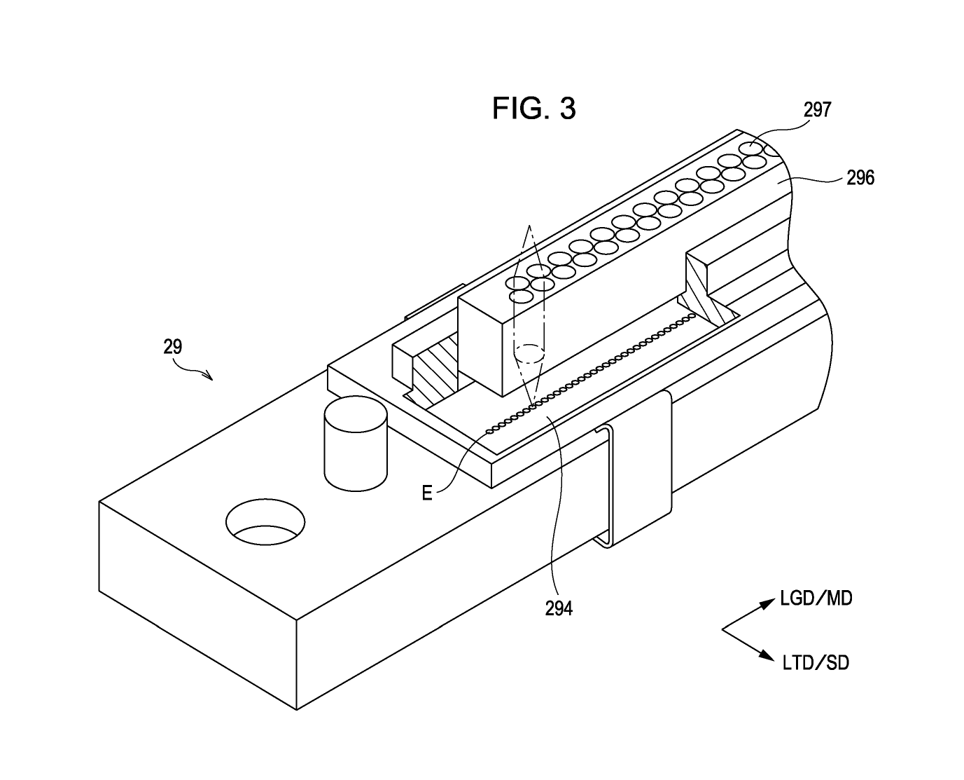

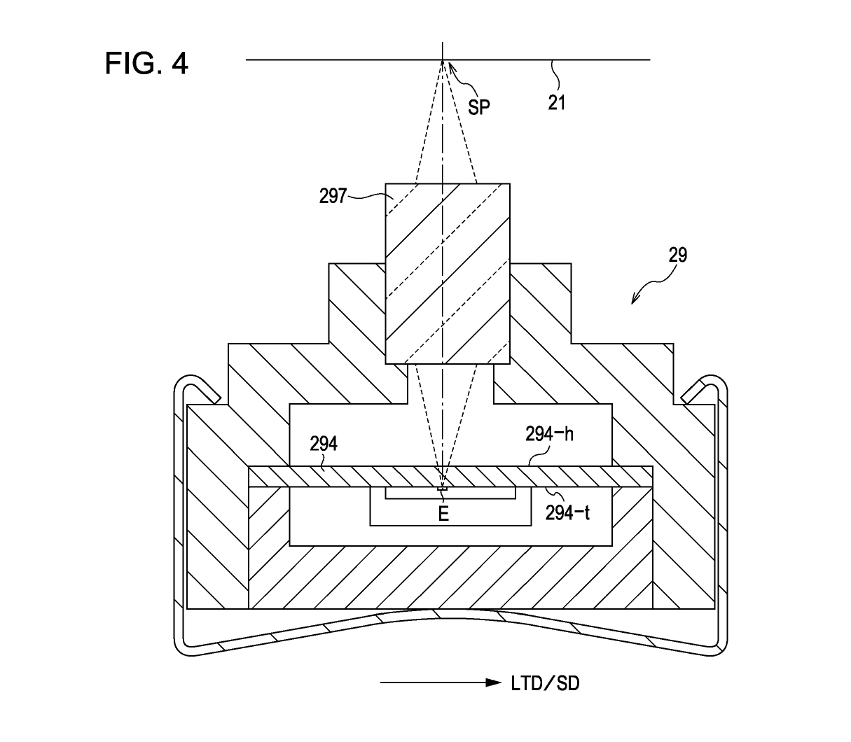

FIG. 3 is a partial perspective view illustrating the structure of the line head. FIG. 4, meanwhile, is a partial cross-section illustrating a widthwise cross-section of the line head. Because these are partial diagrams, all of the parts are not shown. On the back surface 294-t of a head substrate 294 provided in the line head 29, multiple light-emitting elements E are arranged in the lengthwise direction LGD at a pitch based on the resolution of the image forming apparatus. Each light-emitting element E is an organic EL element formed on the head substrate back surface 294-t, and is what is known as a bottom-emission organic EL element. Meanwhile, a graded index rod lens array 297 is disposed facing the front surface 294-h of the head substrate 294. Accordingly, a light beam that has been emitted from the light-emitting element E passes from the back surface 294-t to the front surface 294-h of the head substrate 294, and is then projected at equal magnification by the rod lens array 297. Through this, spots SP are formed upon the surface of the photosensitive drum 21, thereby forming a latent image on the surface of the photosensitive drum 21.

These latent image formation operations performed by the line head 29 are controlled by the main controller MC and the head controller HC. Note that the main controller MC, the head controller HC, and the line heads 29 are each configured of individual blocks, and these blocks are connected to each other via serial connection lines. Data exchange operations performed between these blocks will be described with reference to FIG. 2. When an image formation command is supplied to the main controller MC from an external device, the main controller MC transmits, to the engine controller EC, a control signal for starting the engine unit ENG. Furthermore, an image processing unit 100 provided in the main controller MC performs a predetermined signal process on image data contained in the image formation command, thereby generating video data VD for each of the toner colors.

Meanwhile, having received the control signal, the engine controller EC commences the initialization and warm-up of the various parts of the engine unit ENG. When these operations are completed and the apparatus is in a state in which image formation operations can be executed, the engine controller EC outputs, to the head controller HC that controls the line heads 29, a synchronization signal Vsync, which serves as a trigger to start the image formation operations.

The head controller HC is provided with a head control module 400 that controls the line heads 29 and a head-side communication module 300 that executes data communication with the main controller MC. The main controller MC, meanwhile, is likewise provided with a main-side communication module 200. The main-side communication module 200 outputs, to the head-side communication module 300, one line's worth of video data VD for each request from the head-side communication module 300. The head-side communication module 300 passes this video data VD to the head control module 400. The head control module 400 then causes the light-emitting elements in the line heads 29 to emit light based on the received video data VD. Note that the timing at which the light-emitting elements emit light is controlled based on a horizontal request signal H-req, which will be described later. In other words, the horizontal request signal H-req is a signal supplied at the timing at which the light-emitting elements emit light, and thus the light-emitting elements emit light in synchronization with the horizontal request signal H-req. In this manner, a latent image corresponding to the image formation command is formed upon the surface of the photosensitive drum 21. This latent image is then developed into a toner image by the developing unit 25 (FIG. 1).

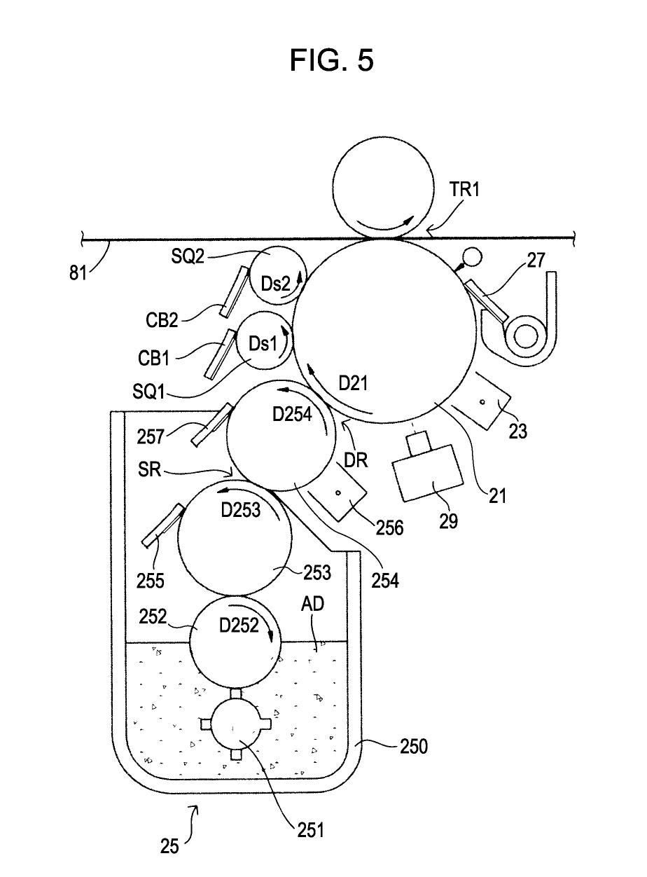

FIG. 5 is a partial diagram illustrating the configuration of the developing unit. The developing unit 25 is provided with a developing agent receptacle 250, and a liquid developer AD is held within the developing agent receptacle 250. The liquid developer AD is a high-viscosity (approximately 100 to 10,000 mPa·s) developing agent in which toner particles are dispersed at a high concentration (approximately 5 to 40 wt %) within a non-volatile and insulative liquid carrier such as silicone oil or the like. The toner particles are composed of a resin, pigment, or the like having an average particle diameter of 0.1 to 5 μm, and are charged. In order to ensure a uniform dispersion state of the toner particles within the liquid carrier, an agitation member 251 that agitates the liquid developer AD is provided within the developing agent receptacle 250.

Furthermore, the developing unit 25 includes a lift roller 252. This lift roller 252 is partially immersed in the liquid developer AD within the developing agent receptacle 250, and lifts out liquid developer AD by rotating in a rotational direction D252 (the clockwise direction in FIG. 5). The liquid developer AD lifted out in this manner is supplied to a developing roller 254 after passing along an intermediate roller 253 (a supply roller).

The intermediate roller 253 is disposed between the lift roller 252 and the developing roller 254, and rotates in a rotational direction D253 (the counterclockwise direction in FIG. 5). Because the rotational direction D253 of the intermediate roller 253 is the opposite direction relative to the rotational direction D252 of the lift roller 252, the surface of the intermediate roller 253 and the surface of the lift roller 252 move in the same direction in the region at which the intermediate roller 253 and the lift roller 252 oppose each other. On the other hand, because the rotational direction D253 of the intermediate roller 253 is the same direction relative to the rotational direction D254 (the counterclockwise direction in FIG. 5) of the developing roller 254, the surface of the intermediate roller 253 and the surface of the developing roller 254 move in opposite directions in the region at which the intermediate roller 253 and the developing roller 254 oppose each other (a supply position SR). The intermediate roller 253 supplies the liquid developer AD to the developing roller 254 at the supply position SR. Meanwhile, the liquid developer AD that has remained on the intermediate roller 253 after passing through the supply position SR is wiped off by a cleaning plate 255.

The developing roller 254 is configured of a metallic inner cylinder made of iron or the like that is covered by an elastic member such as a urethane resin or the like, and forms a nip portion at a developing position DR where the developing roller 254 makes contact with the photosensitive drum 21. This developing roller 254 rotates in the rotational direction D254, and transports the liquid developer AD from the supply position SR to the developing position DR. Meanwhile, a charging unit 256 used for voltage application is disposed between the supply position SR and the developing position DR. This voltage application charging unit 256 is configured of a corona charging unit, and applies a voltage to the developing roller 254 without making contact with the developing roller 254. Due to the supply voltage, charged toner particles within the liquid developer AD held on the developing roller 254 are driven so as to cohere on the surface of the developing roller 254. A toner layer having a predetermined layer thickness is thus formed on the surface of the developing roller 254.

Incidentally, the layer thickness of the toner layer formed at this time can be controlled by adjusting the rotational speed of the intermediate roller 253. In other words, changing the rotational speed of the intermediate roller 253 changes the amount of liquid developer AD that is supplied to the developing roller 254 per unit time, which in turn changes the amount of toner particles, contained in the liquid developer AD, that is supplied per unit time (that is, the amount supplied to the developing roller 254). As a result, the layer thickness of the toner layer formed by the conglomeration of toner particles changes. To summarize, a toner layer having a thick layer thickness can be formed by increasing the rotational speed of the intermediate roller 253, whereas a toner layer having a thin layer thickness can be formed by decreasing the rotational speed of the intermediate roller 253. Note that the adjustment of the speed of the intermediate roller 253 can be executed by the engine controller EC.

A developing bias generation unit (not shown) is electrically connected to the inner cylinder of the developing roller 254. When the developing bias generation unit applies a developing bias to the inner cylinder of the developing roller 254, the charged toner moves from the developing roller 254 to the surface of the photosensitive drum 21 at the developing position DR. In this manner, the latent image on the surface of the photosensitive drum 21 is developed, thereby forming a toner image. Meanwhile, the liquid developer AD that has remained on the developing roller 254 after passing through the developing position DR is wiped off by a cleaning plate 257.

The toner image visualized at the developing position DR is transported in the rotational direction D21 (the clockwise direction in FIG. 5) of the photosensitive drum 21, and then undergoes a primary transfer to the transfer belt 81 at a primary transfer position TR1 where the transfer belt 81 and the photosensitive drum 21 make contact with each other. However, in this embodiment, two squeeze rollers SQ1 and SQ2 are arranged in that order between the developing position DR and the primary transfer position TR1 in the rotational direction D21 of the photosensitive drum 21, and are disposed so as to oppose the surface of the photosensitive drum 21. The squeeze rollers SQ1 and SQ2 are elastic rollers whose surfaces have been finished with an elastic member, and make contact with the photosensitive drum 21 while rotating in respective rotational directions Ds1 and Ds2 (the counterclockwise direction in FIG. 5).

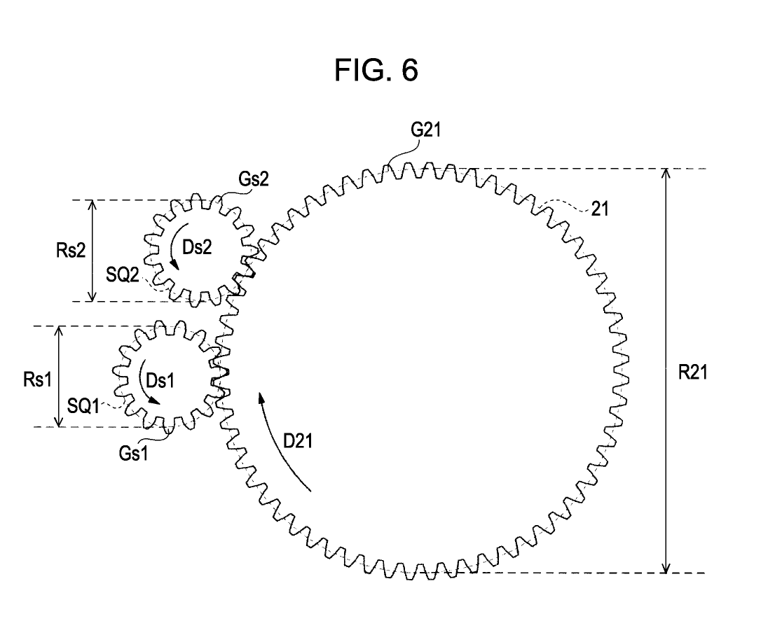

FIG. 6 is a partial side view illustrating a rotation mechanism for squeeze rollers. In FIG. 6, the photosensitive drum 21 and the squeeze rollers SQ1 and SQ2 are indicated by dotted lines. As shown in FIG. 6, a driving transmission gear G21 is attached to the photosensitive drum 21. Accordingly, when driving force from the driving motor DM (FIG. 2) is applied to the photosensitive drum 21 and the photosensitive drum 21 rotates in the rotational direction D21, the driving transmission gear G21 also rotates in the rotational direction D21 in accordance therewith. Meanwhile, squeeze roller gears Gs1 and Gs2 are attached to the squeeze rollers SQ1 and SQ2, respectively, and the squeeze roller gears Gs1 and Gs2 rotate in accordance with the rotation of the squeeze rollers SQ1 and SQ2. The driving transmission gear G21 and the squeeze roller gears Gs1 and Gs2 interlock with each other. Therefore, when the driving transmission gear G21 rotates in the rotational direction D21, the squeeze roller gears Gs1 and Gs2 rotate in the rotational directions Ds1 and Ds2, respectively, which are directions opposite to the rotational direction D21. In this manner, the rotational directions of the squeeze rollers SQ1 and SQ2 are opposite to the rotational direction D21 of the photosensitive drum 21; therefore, the movement direction of the surfaces of the squeeze rollers SQ1 and SQ2 and the movement direction of the surface of the photosensitive drum 21 are the same at the regions where the squeeze rollers SQ1 and SQ2 make contact with the photosensitive drum 21.

Furthermore, the driving transmission gear G21 has 60 teeth, which is four times (an integral multiple) the number of teeth in each of the squeeze roller gears GS1 and GS2 (15). Accordingly, the rotational cycle of the photosensitive drum 21 is four times (an integral multiple) the rotational cycle of the squeeze rollers SQ1 and SQ2. The “rotational cycle” mentioned here refers to the time required by a rotating object (the photosensitive drum 21, the squeeze rollers SQ1 and SQ2) to make one rotation. Furthermore, the ratio of the diameter R21 of the photosensitive drum to the diameters Rs1 and Rs2 of the squeeze rollers SQ1 and SQ2, respectively, is the same as the aforementioned ratio between the numbers of teeth, or four times. Accordingly, the surface speed of the photosensitive drum 21 and the surface speeds of the squeeze rollers SQ1 and SQ2 are equal or approximately equal.

Descriptions will now be resumed from FIG. 5. The squeeze rollers SQ1 and SQ2 make contact with the photosensitive drum 21 while rotating in the manner described above. Accordingly, the squeeze rollers SQ1 and SQ2 squeeze excess liquid carrier from the toner image formed on the surface of the photosensitive drum 21. In particular, the squeeze roller SQ2, which makes contact with the photosensitive drum 21 at the final stage in the rotational direction D21 of the photosensitive drum 21 (to rephrase, the squeeze roller SQ2, which is closest to the primary transfer position TR1), fulfills the role of making the final adjustment on the amount of liquid carrier at the primary transfer position TR1. In this manner, the amount of liquid carrier is adjusted, thereby transporting a toner image having an improved toner particle ratio to the primary transfer position TR1, whereupon the toner image undergoes primary transfer to the transfer belt 81.

A photosensitive drum cleaner 27 that makes contact with the surface of the photosensitive drum 21 is provided on the downstream side of the primary transfer position TR1 and the upstream side of the charging unit 23 in the rotational direction D21 of the photosensitive drum 21. By making contact with the surface of the photosensitive drum, this photosensitive drum cleaner 27 removes toner remaining on the surface of the photosensitive drum 21 following the primary transfer.

Descriptions of the image forming apparatus as a whole will now be resumed from FIG. 1. The transfer belt unit 8 includes a driving roller 82, a slave roller 83 (a blade-opposed roller) provided to the left of the driving roller 82 in FIG. 1, and the transfer belt 81, which is stretched across these rollers and which is cyclically driven in the direction of the arrow D81 in FIG. 1 (the transport direction) by the rotation of the driving roller 82. Furthermore, the transfer belt unit 8 includes four primary transfer rollers 85Y, 85M, 85C, and 85K, which are disposed so as to oppose the photosensitive drums 21 in the image forming stations 2Y, 2M, 2C, and 2K, respectively, when the cartridges are installed. These primary transfer rollers are each electrically connected to respective primary transfer bias generation units (not shown).

When executing the color mode, all of the primary transfer rollers 85Y, 85M, 85C, and 85K shown in FIG. 1 are positioned toward the image forming stations 2Y, 2M, 2C, and 2K, respectively, thereby causing the transfer belt 81 to push toward and make contact with the photosensitive drums 21 in the image forming stations 2Y, 2M, 2C, and 2K, thus forming the primary transfer position TR1 between each photosensitive drum and the transfer belt 21. The toner images formed on the surfaces of the photosensitive drums 21 are transferred onto the surface of the transfer belt 81 at corresponding primary transfer positions TR1 when a primary transfer bias is applied to the primary transfer rollers 85Y, 85M, 85C, and 85K by the primary transfer bias generation units at an appropriate timing. In other words, in the color mode, single-color toner images of each color are superimposed on one another on the transfer belt 81, thereby forming a color image.

Furthermore, the transfer belt unit 8 includes a transfer belt squeeze portion 87 disposed on the downstream side of the black primary transfer roller 85K and the upstream side of the driving roller 82. This transfer belt squeeze portion 87 fulfills a function for removing excess carrier liquid from the surface of the transfer belt 81, thereby improving the toner particle ratio of the toner image transferred onto the surface of the transfer belt 81.

Furthermore, a resist sensor RS is provided opposite to the surface of the transfer belt 81. The resist sensor RS optically detects changes in the reflectance of the surface of the transfer belt 81, thereby detecting the positions of resist marks and so on formed upon the transfer belt 81 as necessary.

A secondary transfer roller 121 is provided in a state in which it can be freely pressed against or removed from the transfer belt 81, and is driven so as to be pressed against or removed from the transfer belt 81 by a secondary transfer roller driving mechanism (not shown). In a state where the secondary transfer roller 121 is pressed against the transfer belt 81, a secondary transfer position TR2 is formed between the secondary transfer roller 121 and the transfer belt 81. A resist roller pair 80 issues a sheet along a discharge path Dpe while adjusting the supply timing thereof, thereby supplying the sheet to the secondary transfer position TR2. At the secondary transfer position TR2, the toner image on the surface of the transfer belt 81 undergoes a secondary transfer onto the sheet.

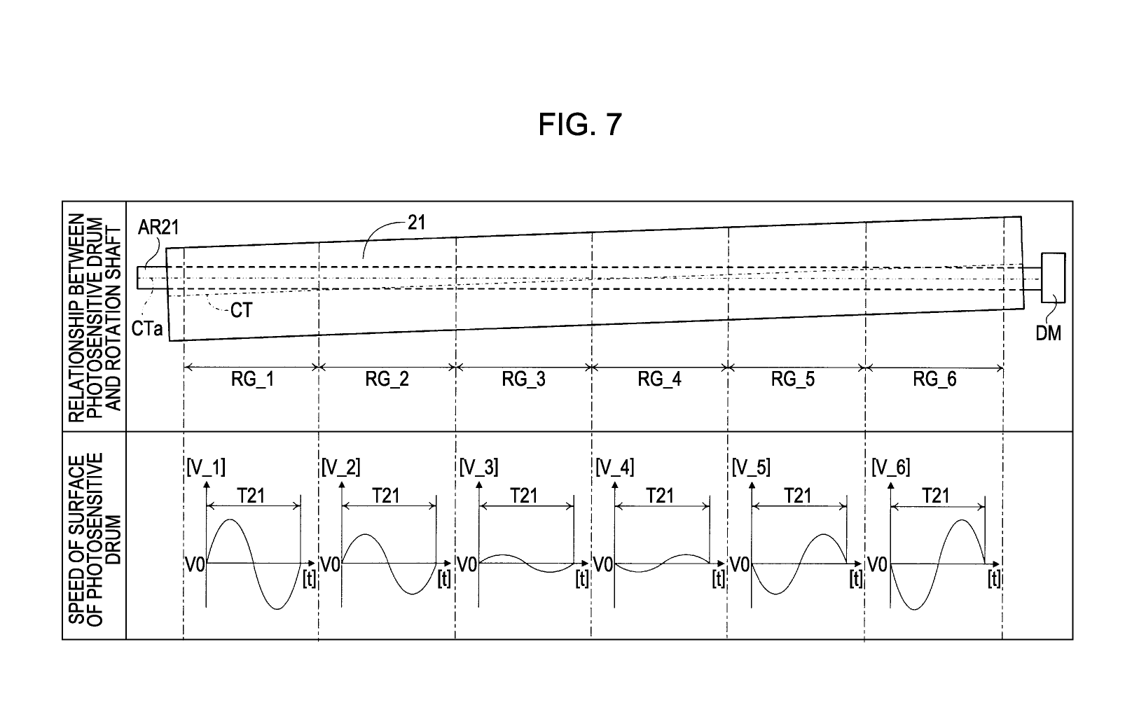

Incidentally, with such an image forming apparatus, it is desirable for the speed of the surface (circumferential surface) of the photosensitive drum 21 (that is, the circumferential speed) to be equal in all regions in the direction of a rotation shaft AR21; however, in reality, there are cases where the circumferential speed differs depending on the region in the direction of the rotation shaft AR21 (FIG. 7). The photosensitive drum 21 slanting relative to the rotation shaft AR21 can be given as a reason for this.

FIG. 7 is a diagram illustrating the surface speed of the photosensitive drum in the case where the photosensitive drum is slanted relative to its rotation shaft. As indicated by the section “relationship between photosensitive drum and rotation shaft” in FIG. 7, the centerline CT of the photosensitive drum 21 is slanted relative to the centerline CTa of the rotation shaft AR21 (in other words, the photosensitive drum 21 is slanted relative to the rotation shaft AR21). Note that in this section, the surface of the photosensitive drum 21 is indicated as having been divided into six different hypothetical regions in the direction of the rotation shaft AR21, or RG_1, RG_2, and so on up to RG_6. Meanwhile, in the section “speed of surface of photosensitive drum” in FIG. 7, the speeds V_1, V_2, and so on up to V_6, which occur when the rotation shaft AR21 is rotationally driven by the driving motor DM in a state in which such slanting is occurring, are indicated for the respective regions RG_1, RG_2, and so on up to RG_6. Here, a speed V0 indicated in this section represents an ideal speed in the case where there is no slant. As shown in FIG. 7, the speeds V_1, V_2, and so on up to V_6 for the respective regions RG_1, RG_2, and so on up to RG_6 are indicated as having different time fluctuations from one another. To be more specific, the amplitude of the fluctuation decreases in order from the speeds V_1, V_2, and V_3 (or the speeds V_6, V_5, and V_4). Furthermore, the phase relationship between the speeds V_1 and V_6 are opposite to each other, and the speeds V_2 and V_5 or V_3 and V._4 also have the same type of phase relationship. Note that the fluctuation cycles are the same for all the speeds V_1, V_2, and so on up to V_6, and are equal to the rotational cycle T21 of the photosensitive drum 21.

In this embodiment, in order to make it possible to execute favorable image formation even in the case where the speeds of the regions RG_1, RG_2, and so on up to RG_6 on the surface of the photosensitive drum 21 differ from each other as shown in FIG. 7, the light-emitting elements E that expose the regions RG_1, RG_2, and so on up to RG_6 are grouped on a region-by-region basis, and the light-emission timings thereof are adjusted on a group-by-group basis.

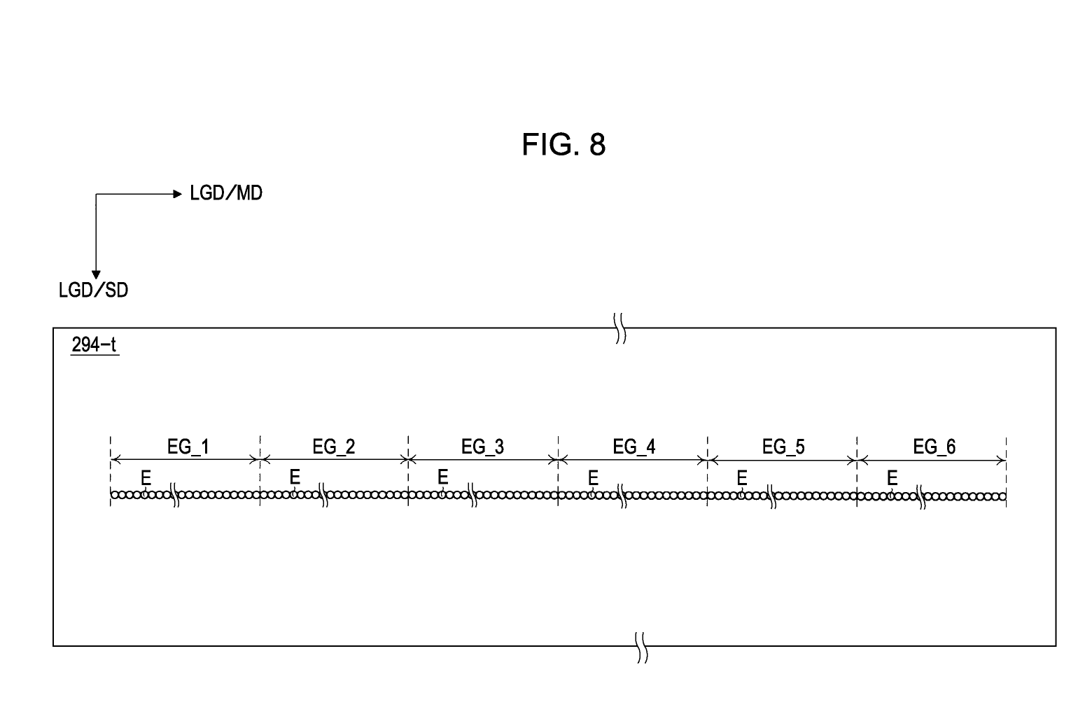

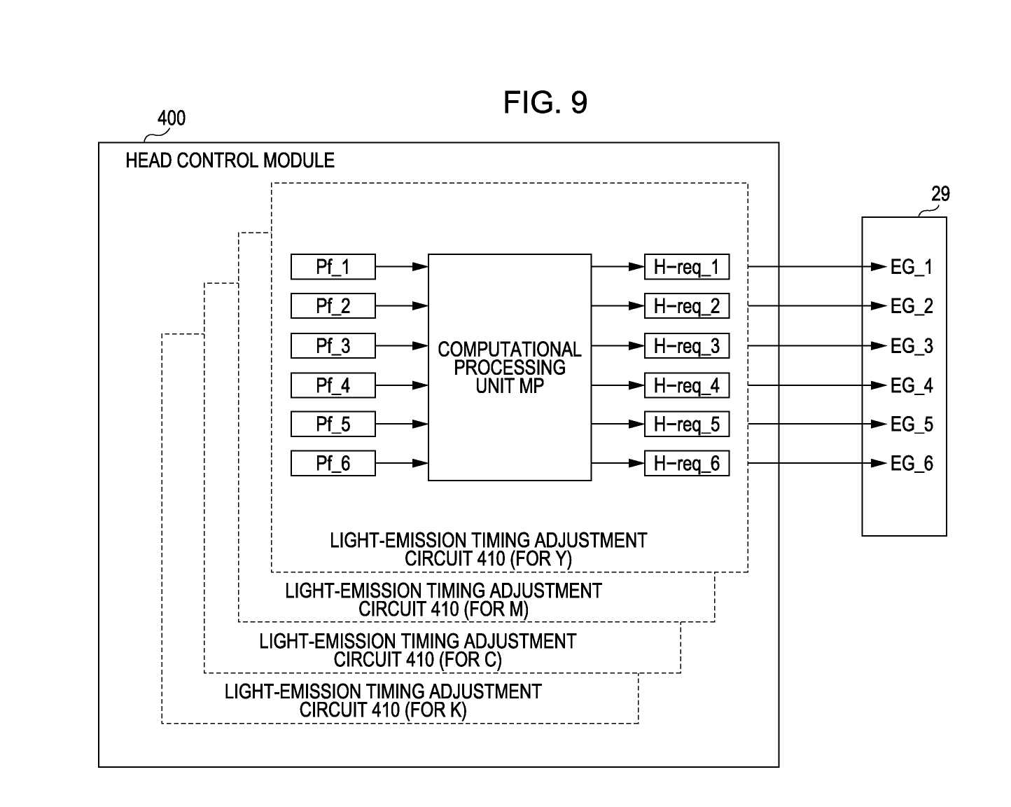

FIG. 8 is a plan view illustrating the grouping of light-emitting elements, and FIG. 9 is a block diagram illustrating an electrical configuration for adjusting the timing of light emission. As shown in FIG. 8, multiple light-emitting elements E are arranged in linear form in the main scanning direction MD on the head substrate back surface 294-t. These light-emitting elements E are grouped in accordance with regions that are to be exposed. In other words, a predetermined number of light-emitting elements E are grouped as a light-emitting element group EG_1 for exposing the region RG_1. In the same manner, predetermined numbers of light-emitting elements E that are to expose the regions RG_2 to RG_6 are grouped as respective light-emitting element groups EG_2 to EG_6. In this embodiment, different horizontal request signals H-req_1 to H-req_6 are prepared for the light-emitting element groups EG_1 to EG_6, respectively. Furthermore, the horizontal request signals H-req_1 to H-req_6 are adjusted in accordance with the speeds of the respective regions RG_1, RG_2, and so on up to RG_6 that are exposed by the light-emitting element groups EG_1 to EG_6 corresponding to the respective stated horizontal request signals. Details of the adjustment operations will be given hereinafter using FIG. 2 and FIG. 9. However, because these adjustment operations are common for each color, the following descriptions will discuss only yellow (Y), and descriptions of the other colors (M, C, and K) will be omitted.

As described above, the photosensitive member cartridge CR-Y is provided with a memory MM (FIG. 2). Profiles Pf_1 to Pf_6, for adjusting the horizontal request signals H-req_1 to H-req_6, respectively, are stored in advance in the memory MM. In other words, the photosensitive member cartridge CR-Y is attached to a profile measurement tool prior to shipment. With this profile measurement tool, laser displacement gauges are provided opposite to the respective regions RG_1, RG_2, and so on up to RG_6 on the surface of the photosensitive drum 21, and each laser displacement gauge detects the distance to the region it opposes. Furthermore, with the profile measurement tool, each laser displacement gauge is positioned relative to the centerline CTa of the rotation shaft AR21 of the photosensitive drum 21, and as a result, the distance between each laser displacement gauge and the centerline CTa is constant regardless of the rotation of the rotation shaft AR21. Therefore, if slanting such as that shown in FIG. 7 occurs, the distance between each laser displacement gauge and its respective region RG_1, RG_2, and so on up to RG_6 changes as the photosensitive drum 21 rotates. Then, based on the fluctuation over time of the distance detected by the laser displacement gauges, the profile measurement tool calculates the speed fluctuations in the regions RG_1, RG_2, and so on up to RG_6 across the photosensitive drum cycle T21, and stores the results of these calculations in the memory MM as the profiles Pf_1 to Pf_6 (these correspond to the graphs in FIG. 7 indicating the fluctuation over time of the speeds V_1 to V_6).

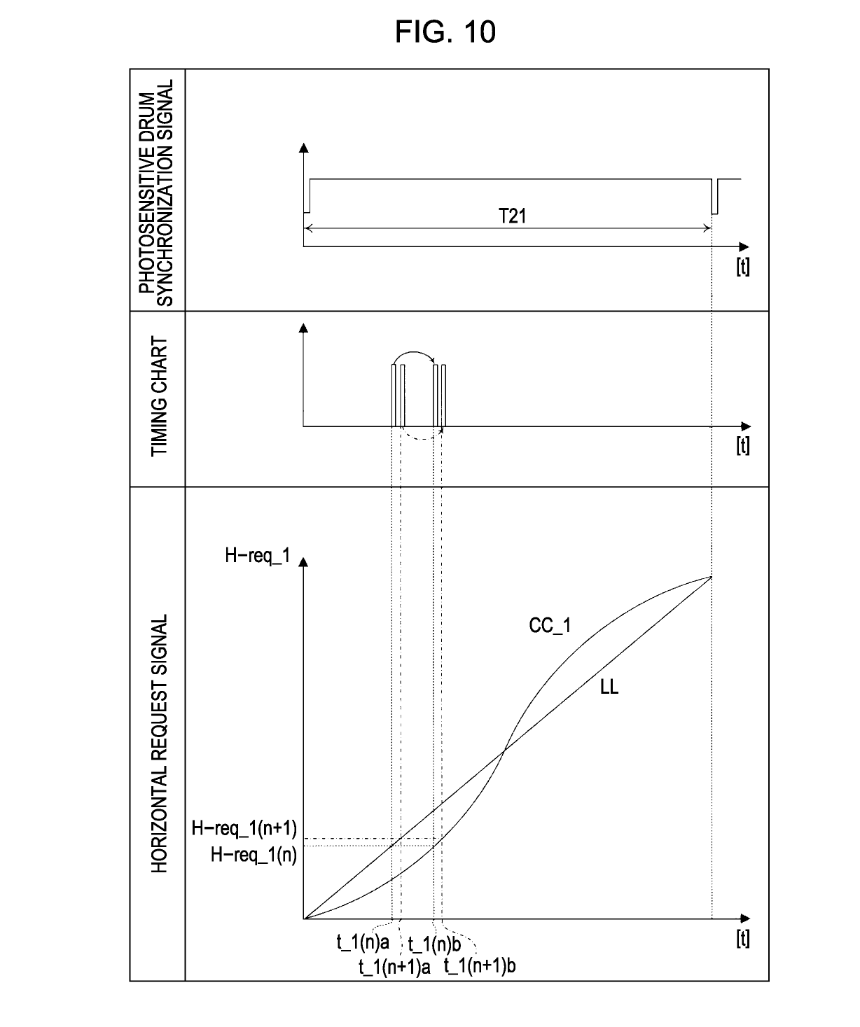

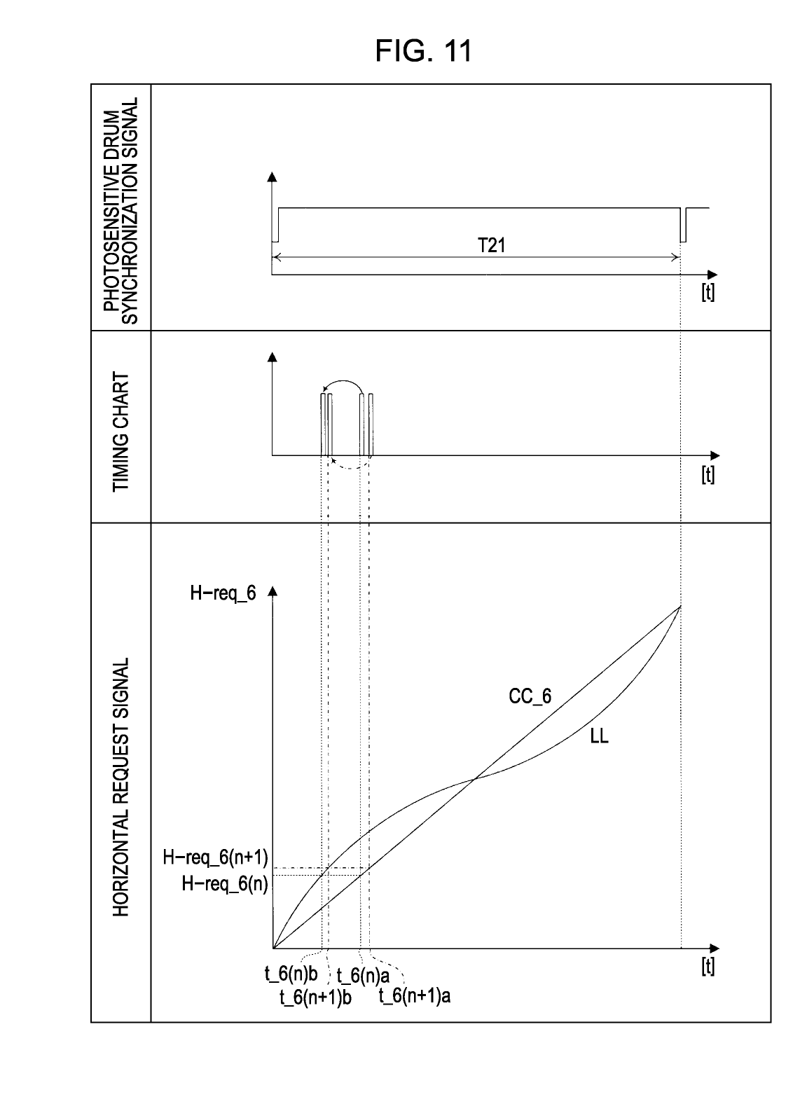

After this photosensitive member cartridge CR-Y has been shipped, it is installed and used in the image forming apparatus. Once the photosensitive member cartridge CR-Y has been installed, the engine controller EC reads out the profiles Pf_1 to Pf_6 from the memory MM of the photosensitive member cartridge CR-Y and stores those profiles in a light-emission timing adjustment circuit 410 provided in the head control module 400 (FIG. 9). A computational processing unit MP in the light-emission timing adjustment circuit 410 calculates compensation curves CC_1, CC_2, and so on up to CC_6 from the respective profiles Pf_1 to Pf_6 (FIGS. 10 and 11), and performs compensation on the horizontal request signals H-req based on those compensation curves CC_1 to CC_6. Details of this will be given hereinafter.

FIG. 10 is a diagram illustrating compensation operations for the horizontal request signal H-req_1 based on the profile Pf_1. FIG. 11, meanwhile, is a diagram illustrating compensation operations for the horizontal request signal H-req_6 based on the profile Pf_6. Although compensation is performed on the horizontal request signals H-req_1 to H-req_6 based on the profiles Pf_1 to Pf_6, respectively, in this embodiment, all of the compensation operations are identical in nature, and therefore the compensation operations performed on the horizontal request signals based on the profiles Pf_1 and Pf_6 will be described hereinafter as representative examples.

The signal indicated in the sections “photosensitive drum synchronization signal” shown in FIGS. 10 and 11 is a signal that is outputted with each cycle T21 of the photosensitive drum 21. Using this photosensitive drum synchronization signal as a trigger, horizontal request signals H-req of a number based on the resolution are sequentially outputted during the cycle T21. Compensation is performed on each horizontal request signal H-req in the manner indicated in the sections “timing chart” based on the compensation curves CC_1 and CC_6 indicated in the sections “horizontal request signal”. These compensation curves CC_1 and CC_6 provide output timings to the post-compensation horizontal request signals H-req, and are calculated from the aforementioned profiles Pf_1 and Pf_6 across the photosensitive drum cycle T21. Note that straight lines LL given to the pre-compensation horizontal request signals H-req are also denoted in the “horizontal request signal” section in order to facilitate understanding of the compensation operations.

First, the compensation operations shown in FIG. 10 (in other words, the compensation operations for the horizontal request signal H-req_1) will be described in detail. For example, prior to the compensation, the output timing of the nth horizontal request signal H-req_1(n) from the photosensitive drum synchronization signal is a time t_1(n)a provided by the straight line LL; however, after the compensation, this timing is a time t_1(n)b provided by the compensation curve CC. Furthermore, prior to the compensation, the output timing of the (n+1)th horizontal request signal H-req_1(n+1) is a time t_1(n+1)a provided by the straight line LL; however, after the compensation, this timing is a time t_1(n+1)b provided by the compensation curve CC. In this manner, the post-compensation nth and (n+1)th horizontal request signals H-req_1 are adjusted so as to be outputted at a timing that is slower than the pre-compensation timing (see the “timing chart” section), and the light-emission timing of the light-emitting elements E in the light-emitting element group EG_1 is delayed as a result of these compensation operations. This is because as shown in the “photosensitive drum surface speed” section in FIG. 7, the speed of the region RG_1 has fluctuated so as to be faster in the first half of the photosensitive drum cycle T21, and the light-emission timing of the light-emitting elements E has been delayed in order to eliminate the influence of that speed fluctuation on the image. Meanwhile, as can be seen from the “horizontal request signal” section in FIG. 10, the light-emission timing of the light-emitting elements E in the light-emitting element group EG_1 is earlier in the second half of the photosensitive drum cycle T21 due to the compensation operations. This is because as shown in the “photosensitive drum surface speed” section in FIG. 7, the speed of the region RG_1 has fluctuated so as to be slower in the second half of the photosensitive drum cycle T21, and the light-emission timing of the light-emitting elements E has been made earlier in order to eliminate the influence of that speed fluctuation on the image.

Next, the compensation operations shown in FIG. 11 (in other words, the compensation operations for the horizontal request signal H-req_6) will be described in detail. For example, prior to the compensation, the output timing of the nth horizontal request signal H-req_6(n) from the photosensitive drum synchronization signal is a time t_6(n) a provided by the straight line LL; however, after the compensation, this timing is a time t_6(n) b provided by the compensation curve CC. Furthermore, prior to the compensation, the output timing of the (n+1)th horizontal request signal H-req_6(n+1) is a time t_6(n+1)a provided by the straight line LL; however, after the compensation, this timing is a time t_6(n+1)b provided by the compensation curve CC. In this manner, the post-compensation nth and (n+1)th horizontal request signals H-req_6 are adjusted so as to be outputted at a timing that is earlier than the pre-compensation timing (see the “timing chart” section), and the light-emission timing of the light-emitting elements E in the light-emitting element group EG_6 is made earlier as a result of these compensation operations. This is because as shown in the “photosensitive drum surface speed” section in FIG. 7, the speed of the region RG_6 has fluctuated so as to be slower in the first half of the photosensitive drum cycle T21, and the light-emission timing of the light-emitting elements E has been made earlier in order to eliminate the influence of that speed fluctuation on the image. Meanwhile, as can be seen from the “horizontal request signal” section in FIG. 11, the light-emission timing of the light-emitting elements E in the light-emitting element group EG_6 is delayed in the second half of the photosensitive drum cycle T21 due to the compensation operations. This is because as shown in the “photosensitive drum surface speed” section in FIG. 7, the speed of the region RG_6 has fluctuated so as to be faster in the second half of the photosensitive drum cycle T21, and the light-emission timing of the light-emitting elements E has been delayed in order to eliminate the influence of that speed fluctuation of the image.

As described thus far, in this embodiment, the light-emitting elements in the light-emitting element groups EG_1 to EG_6 expose the regions RG_1 to RG_6, which are different from each other, on the surface of the photosensitive drum 21. As described using FIG. 7, there are cases where the speed of the regions RG_1 to RG_6 differ from each other, and in such a case, there has been a risk of the occurrence of image formation defects such as the image transferred onto the surface of the transfer belt 81 distorting. In response to this, in this embodiment, the horizontal request signals H-req_1 to H-req_6, which apply light-emission timings to the light-emitting elements E in the light-emitting element groups EG_1 to EG_6, are adjusted based on the profiles Pf_1 to Pf_6 that are associated with the speeds of the regions RG_1 to RG_6 (FIGS. 9, 10, and 11). Accordingly, it is possible to suppress image formation defects such as those described above and favorably form images even in the case where the speeds of the regions RG_1 to RG_6 differ from each other.

Furthermore, as indicated in FIG. 7, a complicated situation where the speeds of the regions RG_1 to RG_6 fluctuate to various degrees over time can arise due to the photosensitive drum 21 slanting relative to the rotation shaft AR21. However, such speed fluctuation in the regions RG_1 to RG_6 is cyclic, and that cycle is equivalent to the cycle T21 of the photosensitive drum 21. Accordingly, in this embodiment, the profiles Pf_1 to Pf_6 are found across the cycle T21 of the photosensitive drum 21 (that is, the profiles Pf_1 to Pf_6 are associated with the speeds within the cycle T21 of the regions RG_1 to RG_6 to which those respective profiles correspond). As a result, compensation can be performed on the horizontal request signals H-req_1 to H-req_6 across the cycle T21 of the photosensitive drum 21 based on those profiles Pf_1 to Pf_6, and thus even in the case where such a complicated speed fluctuation occurs, it is possible to favorably form an image regardless of that speed fluctuation.

Incidentally, when using such a method in which compensation is performed on the horizontal request signals H-req based on the profiles Pf_1 to Pf_6 found across the cycle T21 of the photosensitive drum 21, it is preferable for the speed fluctuation of the regions RG_1 to RG_6 to be cyclic in the cycle T21. However, with a configuration in which squeeze rollers SQ1 and SQ2 that make contact with the photosensitive drum 21 are provided, as described above, there is a risk that the cyclicity of the speed fluctuation in the regions RG_1 to RG_6 will break down. In other words, the amount of liquid carrier tends to decrease in the vicinity of the squeeze rollers SQ1 and SQ2 (for example, compared to the vicinity of the developing position DR), and if the amount of the liquid carrier decreases in this manner, the operations of the squeeze rollers SQ1 and SQ2 will influence the speed of the regions RG_1 to RG_6, leading to a risk that the cyclicity in the cycle T21 of the speed fluctuation of the regions RG_1 to RG_6 will break down. In response to this, in this embodiment, the rotational cycle of the photosensitive drum 21 is an integral multiple of the rotational cycle of the squeeze rollers SQ1 and SQ2. Accordingly, even if the squeeze rollers SQ1 and SQ2 are influenced by the speeds of the regions RG_1 to RG_6, the cyclicity in the cycle T21 of the speed fluctuation in the regions RG_1 to RG_6 can be maintained. As a result, the configuration of this embodiment is advantageous with respect to favorable image formation.

In particular, there is even less liquid carrier in the vicinity of the squeeze roller SQ2 than that in the vicinity of the squeeze rollers SQ1, and thus the squeeze roller SQ2 tends to easily influence the movement speed of the regions RG_1 to RG_6 of the photosensitive drum 21; there is therefore a large risk of a breakdown of the cyclicity of the cycle T21 of the regions RG_1 to RG_6. In response to this, in this embodiment, the rotational cycle of the photosensitive drum 21 is an integral multiple of the rotational cycle of the squeeze roller SQ2, thus making it possible to sufficiently suppress a breakdown in the cyclicity in the cycle T21 due to the squeeze roller SQ2, which is advantageous in terms of favorable image formation.

Incidentally, there has been the risk that image formation defects occurring due to different speeds in the regions RG_1, RG_2, and so on up to RG_6 on the surface of the photosensitive drum 21 has led to serious problems, particularly in a configuration that uses the liquid developer AD, as in this embodiment. This is because the liquid developer AD has viscous friction. This point will now be described in detail.

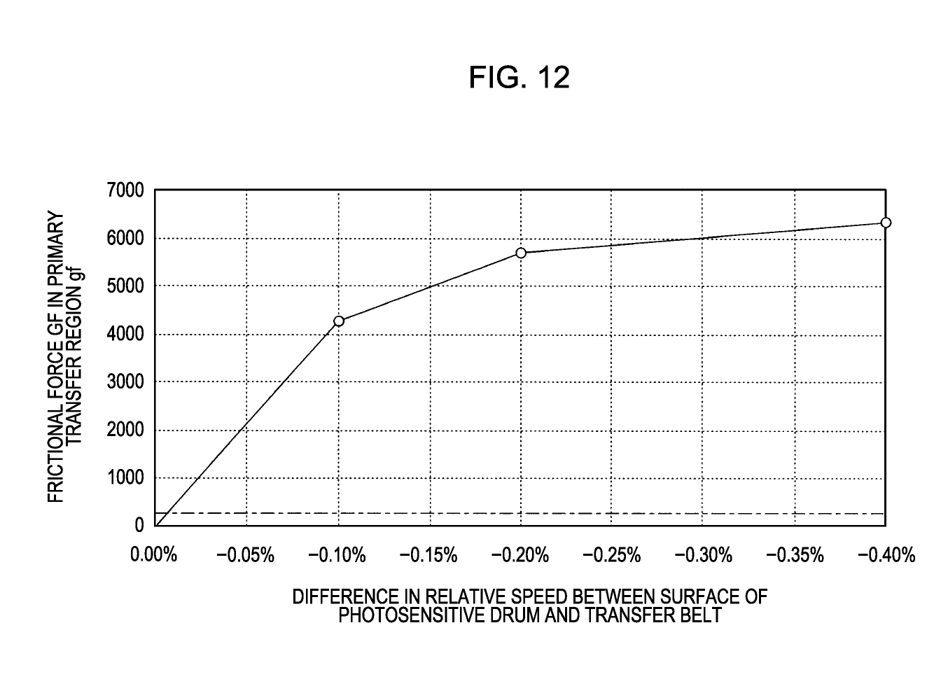

FIG. 12 is a graph illustrating frictional force that acts between the surface of the transfer belt and the surface of the photosensitive drum in the primary transfer region. The horizontal axis in FIG. 12 expresses the difference in speed between the surface of the transfer belt 81 and the surface of the photosensitive drum 21 as a percentage, and the vertical axis in FIG. 12 expresses the frictional force arising at the primary transfer region TR1. Furthermore, the solid line in FIG. 12 indicates the frictional force in the case where a liquid developer is used, whereas the dot-dash line in FIG. 12 indicates the frictional force in the case where a liquid carrier is not used, or in other words, the case where a dry developing agent is used.

As indicated by the dot-dash line in FIG. 12, with a configuration that uses a dry developing agent, the frictional force that arises at the primary transfer region TR1 is approximately constant regardless of the difference in speed between the surface of the transfer belt 81 and the surface of the photosensitive drum 21. On the other hand, as indicated by the solid line in FIG. 12, with a configuration that uses a liquid developer, the frictional force that arises at the primary transfer region TR1 fluctuates depending on the difference in the speed between the surface of the transfer belt 81 and the surface of the photosensitive drum 21. Accordingly, with the configuration that uses the liquid developer AD, there are situations where the frictional force that fluctuates depending on the difference in speed between the surface of the transfer belt 81 and the surface of the photosensitive drum 21 causes the transfer belt 81 to extend or compress. In such a situation, if the speed between the surface of the photosensitive drum 21 and the regions RG_1, RG_2, and so on up to RG_6 differ from each other, a difference in the degree of extension/compression of the surface of the transfer belt 81 will occur in the direction of the rotation shaft AR21, thus leading to a risk of complex distortions occurring in the post-transfer image. This image distortion becomes a more serious problem as the resolution increases. In other words, despite the advantage of liquid developer being more useful in realizing high-resolution images than dry developing agents, there has been a problem in that this advantage of liquid developer cannot be exploited to the fullest extent when differences in the speed between the surface of the photosensitive drum 21 in the regions RG_1, RG_2, and so on up to RG_6 occur. In response to this, with this embodiment, it is possible to realize high-resolution image formation using a liquid developer while suppressing the occurrence of complex distortions in the post-transfer image, and thus it can be said that a configuration that uses a liquid developer is extremely useful.

Thus, in this embodiment, the photosensitive drum 21 corresponds to a “latent image bearing drum” according to the invention; the line head 29 corresponds to an “exposure head” according to the invention; the profiles Pf_1 to Pf_6 correspond to “speed-related information” according to the invention; the memory MM or the light-emission timing adjustment circuit 410 corresponds to a “storage unit” according to the invention; and the light-emission timing adjustment circuit 410 corresponds to a “light-emission timing adjustment unit” according to the invention.

Note that the invention is not limited to the aforementioned embodiment, and various modifications can be added to the aforementioned embodiment without departing from the essential spirit thereof. For example, in the aforementioned embodiment, a photosensitive member cartridge before shipment is attached to a profile measurement tool, and the profiles Pf_1 to Pf_6 are found thereby. However, the method for finding the profiles Pf_1 to Pf_6 is not limited thereto, and, for example, the profiles Pf_1 to Pf_6 may be found by performing a resist mark between image formation operations.

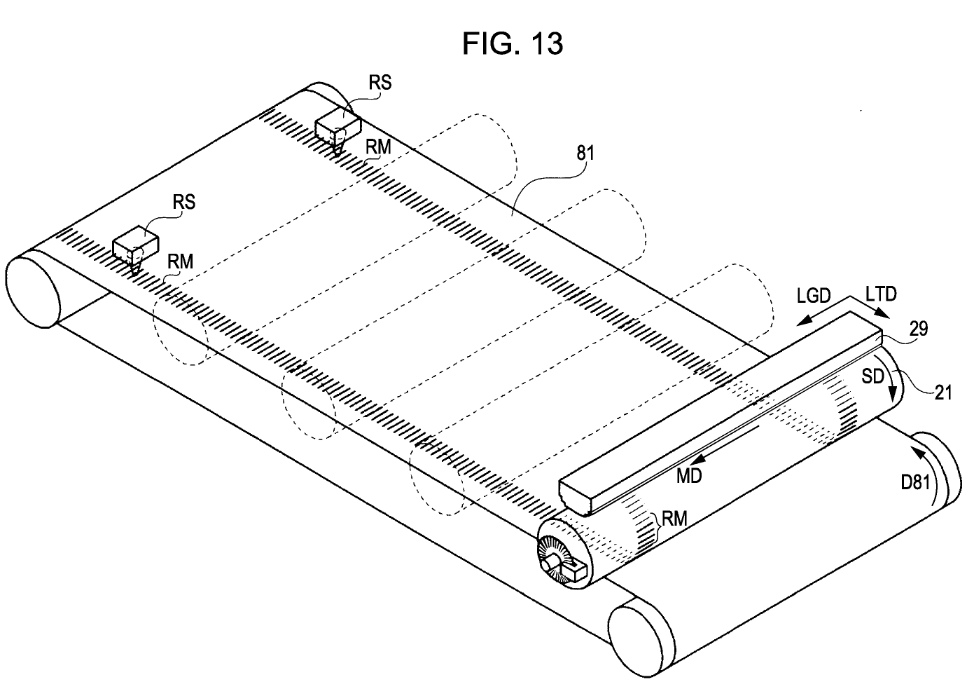

FIG. 13 is a partial perspective view illustrating another method for finding a profile. As shown in FIG. 13, a resist sensor RS that opposes the surface of the transfer belt 81 is provided on both sides of the main scanning direction MD (in the direction of the rotation shaft AR21 of the photosensitive drum). Resists marks RM formed on both sides of the surface of the transfer belt 81 in the main scanning direction MD are detected by the resist sensors RS. The engine controller EC (FIG. 2) finds, based on the detection results obtained by the resist sensors RS, skew in the formation positions of the resist marks RM caused by different speeds in the regions RG_1, RG_2, and so on up to RG_6 in the surface of the photosensitive drum 21, calculates the profiles Pf_1 to Pf_6 from the results of finding the position skew, and stores the profiles in the light-emission timing adjustment circuit 410. Note that with the embodiment shown in FIG. 13, the resist marks RM are formed in ranges that corresponds to the regions RG_1 and RG_6. While the profiles Pf_1 and Pf_6 are found directly from the results of detecting the respective resist marks RM, the profiles Pf_2 to Pf_5 are found using a calculation method, such as linear interpolation or the like, based on the results of detecting the resist marks RM.

Incidentally, a situation where the cyclicity in the cycle T21 of the speed fluctuation in the regions RG_1, RG_2, and so on up to RG_6 in the surface of the photosensitive drum 21 is disturbed by the developing roller 254 that makes contact with the surface of the photosensitive drum 21 can be considered, depending on the amount of liquid carrier that the liquid developer AD contains. Accordingly, the configuration may be such that the rotational cycle T21 of the photosensitive drum 21 is an integral multiple of the developing roller 254. The reason for this is that such a configuration is capable of maintaining the cyclicity in the cycle T21 of the speed fluctuation of the regions RG_1, RG_2, and so on up to RG_6 of the surface of the photosensitive drum 21, and is thus advantageous in terms of favorable image formation.

In addition, in the aforementioned embodiment, the charging unit 23 is configured of a non-contact corona charging unit. However, the configuration of the charging unit 23 is not limited thereto, and the charging unit 23 may be configured of a charge roller that charges the photosensitive drum 21 by making contact with the surface thereof. However, in such a case, because the charge roller makes contact with the photosensitive drum 21, a situation in which the charge roller affects the speed of the regions RG_1, RG_2, and so on up to RG_6 of the surface of the photosensitive drum 21, causing a breakdown in the cyclicity in the cycle T21 of the speed fluctuations of the regions RG_1, RG_2, and so on up to RG_6, can be considered. Accordingly, the configuration may be such that the rotational cycle T21 of the photosensitive drum 21 is an integral multiple of the rotational cycle of the charge roller. The reason for this is that such a configuration is capable of maintaining the cyclicity in the cycle T21 of the speed fluctuation of the regions RG_1, RG_2, and so on up to RG_6 of the surface of the photosensitive drum 21, and is thus advantageous in terms of favorable image formation.

Note that although in the aforementioned embodiment, the profiles Pf_1 to Pf_6 are found across the cycle T21 of the photosensitive drum 21, the period for finding the profiles Pf_1 to Pf_6 is not limited to this period.

Furthermore, although in the aforementioned embodiment, the rotational cycle T21 of the photosensitive drum 21 is described as being an integral multiple of the rotational cycle of the squeeze rollers SQ1 and SQ2, the developing roller 254, or the charge roller, the rotational cycle T21 of the photosensitive drum 21 is not limited thereto.

In the aforementioned embodiment, the configuration is such that the surface of the photosensitive drum is divided into six hypothetical regions, or RG_1 to RG_6, and six profiles Pf_1 to Pf_6 and six horizontal request signals H-req_1 to H-req_6 that have undergone compensation based on those profiles are prepared in correspondence with the stated regions, and furthermore, light-emitting element groups EG_1 to EG_6 emit light in synchronization with the horizontal request signals. However, the number of divisions in the surface of the photosensitive drum 21 is not limited thereto, and can be changed as appropriate; the number of profiles, horizontal request signals, and light-emitting element groups may then be changed based on the change in the number of divisions.

In the aforementioned embodiment, the configuration is such that profiles Pf_1 to Pf_6 are found for all of the six regions RG_1 to RG_6. However, this type of configuration is not absolutely necessary, and for example, the profiles Pf_1 to Pf_6 may be found only for the two regions RG_1 and RG_6, of the six regions RG_1 to RG_6, whose speed fluctuation is particularly high. Furthermore, the configuration may be such that compensation is then be performed on the horizontal request signals H-req_1 and H-req_6 for the two light-emitting element groups EG_1 and EG_2 that expose those regions RG_1 and RG_6 based on the profiles Pf_1 and Pf_6, with no particular compensation being performed in the horizontal request signals for the other light-emitting element groups.

Furthermore, although the multiple light-emitting elements E are arranged in linear form in the lengthwise direction LGD in the aforementioned embodiment, the multiple light-emitting elements E may be arranged in the lengthwise direction LGD in a two-row hound's tooth pattern or a hound's tooth pattern having three or more rows.

Furthermore, although organic EL elements are used as the light-emitting elements E in the aforementioned embodiment, LEDs (light-emitting diodes) may be used as a light-emitting element E.

Furthermore, the configuration of the line head 29 is not limited to that described above, and for example, a line head 29 configured as denoted in JP-A-2008-036937, JP-A-2008-36939, or the like can be used. However, with the line heads 29 denoted in these publications, multiple light-emitting elements are arranged in a hound's tooth pattern, thereby configuring a single light-emitting element group; furthermore, multiple light-emitting element groups are arranged two-dimensionally. Accordingly, multiple light-emitting elements are disposed in positions that are different from each other in the sub scanning direction SD. Accordingly, as disclosed in, for example, FIG. 11 in JP-A-2008-36937, with such a line head 29, the light-emitting elements disposed in positions that are different from each other in the sub scanning direction ST are controlled so as to emit light at different timings. Therefore, when applying such a line head 29 in this invention, horizontal request signals H-req may be provided for each of the multiple light-emitting elements disposed in positions that are different from each other in the sub scanning direction SD.

In the aforementioned embodiment, the rotation shafts AR21 of the photosensitive drums 21 are rotationally driven directly by respective dedicated driving motors DM. However, driving force transmission systems such as gears and the like may be provided between the rotational shafts AR21 and the driving motors DM.

The entire disclosure of Japanese Patent Application No: 2009-54671, filed Mar. 9, 2009 is expressly incorporated by reference herein.

What is claimed is:

1. An image forming apparatus comprising:
a latent image bearing drum that rotates and on which a latent image is formed;
an exposure head having a first light-emitting element that exposes a first region of the latent image bearing drum and a second light-emitting element that exposes a second region of the latent image bearing drum;
a storage unit that stores first speed-related information relating to the rotational speed of the first region of the latent image bearing drum and second speed-related information relating to the rotational speed of the second region of the latent image bearing drum; and
a light-emission timing adjustment unit that adjusts the timing of the light emission of the first light-emitting element based on the first speed-related information and adjusts the timing of the light emission of the second light-emitting element based on the second speed-related information.

2. The image forming apparatus according to claim 1,
wherein the first speed-related information relates to the rotational speed of the first region during the period in which the latent image bearing drum makes one rotation; and
the second speed-related information relates to the rotational speed of the second region during the period in which the latent image bearing drum makes one rotation.

3. The image forming apparatus according to claim 2, further comprising:
a developing unit that develops the latent image formed on the latent image bearing drum using a liquid developer that contains a liquid carrier and toner; and
a first squeeze roller that makes contact with the latent image bearing drum and removes the liquid carrier from an image developed by the developing unit,
wherein the rotational cycle of the latent image bearing drum is an integral multiple of the rotational cycle of the first squeeze roller.

4. The image forming apparatus according to claim 3, further comprising:
a second squeeze roller that makes contact with the latent image bearing drum and removes the liquid carrier from the image from which the liquid carrier has been removed by the first squeeze roller,
wherein the rotational cycle of the latent image bearing drum is an integral multiple of the rotational cycle of the second squeeze roller.

5. The image forming apparatus according to claim 3,
wherein the developing unit includes a developing roller that makes contact with the latent image bearing drum and supplies the liquid developer to the latent image bearing drum; and
the rotational cycle of the latent image bearing drum is an integral multiple of the rotational cycle of the developing roller.

6. The image forming apparatus according to claim 2, further comprising:
a charge roller that makes contact with the latent image bearing drum and charges the latent image bearing drum,
wherein the rotational cycle of the latent image bearing drum is an integral multiple of the rotational cycle of the charge roller.

7. An image forming method comprising:
adjusting the timing of the light emission of a first light-emitting element that exposes a first region of a latent image bearing drum that rotates and which is exposed to form a latent image, based on first speed-related information relating to the rotational speed of the first region of the latent image bearing drum; and
adjusting the timing of the light emission of a second light-emitting element that exposes a second region of a latent image bearing drum that rotates and which is exposed to form a latent image, based on second speed-related information relating to the rotational speed of the second region of the latent image bearing drum.
